(19) United States
(12) Patent Application Publication
(10) Pub. No.: US 2004/0251957 A1
(43) Pub. Date: Dec. 16, 2004

(54) Internal voltage generator

(76) Inventor: Chang Ho Do, Kyoungki-do (KR)

Correspondence Address: LADAS & PARRY LLP, 224 SOUTH MICHIGAN AVENUE, SUITE 1200, CHICAGO, IL, 60604, US

(21) Appl. No.: 10/736,816

(22) Filed: Dec. 16, 2003

(30) Foreign Application Priority Data
Jun. 10, 2003 (KR) 2003-37149

(51) Int. Cl. G05F 1/10

(52) U.S. Cl. 327/541

(57) ABSTRACT

An internal voltage generator for performing the restoration of an output voltage to a target value despite variance of an internal voltage includes a reference voltage divider that generates first and second reference voltages, and a first differential amplifier that receives the first reference voltage from reference voltage divider through a first input terminal of first differential amplifier and generates a first differential signal. A second differential amplifier receives the second reference voltage from the reference voltage divider through a first input terminal of second differential amplifier and generates a second differential signal. A voltage source driver is driven by the first and second differential signals from first and second differential amplifiers, respectively, and provides a driver voltage within a desired and adjustable range.

### BACKGROUND OF THE INVENTION

1. Field of the invention

The present invention relates generally to an internal voltage generator, and more particularly to an internal voltage generator which generates a bit line precharge voltage or a cell plate voltage wherein the bit line precharge voltage is used for a bit line of a semiconductor memory device and the cell plate voltage is used for a memory cell plate of the semiconductor memory device.

2. Description of the Background Art

As is generally known in the art, an external voltage is applied to a semiconductor device but is not directly used in an internal circuit of the semiconductor device. One reason is to avoid problems wherein the internal circuit of the semiconductor device operates erroneously when directly applying the external voltage to the internal circuit. A second reason is that the potential level is unstable because the external voltage includes noise that is usually undesirably input into the semiconductor integrated circuit, with the potential to cause errors in the data.

Due to the above reasons, after the external voltage, which is applied to the semiconductor device, passes through an internal buffer, it is conventionally used as an internal voltage. The internal voltage includes a plate voltage VCP of a memory cell capacitor, a bit line precharge voltage VBLP, and a body power supply VBB of a memory cell transistor. The present invention relates to an internal voltage generator which generates the plate voltage VCP of a memory cell capacitor and the bit line precharge voltage VBLP.

In general, a semiconductor memory device is divided into a core area and a peripheral area. The core area has a memory cell area. A core voltage generator is installed in the peripheral area of the semiconductor memory device and generates an internal voltage for driving the core area having the memory cell area.

The semiconductor memory device includes a memory cell and an internal voltage generator. The memory cell functions as a data storage device. The semiconductor memory device includes an internal voltage generator generating a specific voltage based on data of a high level voltage (that is, a core voltage) stored in a memory cell. The present invention relates to an internal voltage generator, which normally outputs half of the predetermined core voltage, because the plate voltage VCP of a memory cell capacitor or the bit line precharge voltage VBLP needs only half of the core voltage for its operation.

Hereinafter, as an example of a conventional internal voltage generator for the semiconductor device, a conventional internal generator for generating half of a core voltage will be described with reference to FIG. 1.

FIG. 1 is a circuit diagram showing a conventional internal generator that generates an internal voltage whose magnitude is half of a core voltage.

As shown in FIG. 1, the conventional internal voltage generator uses a core voltage as its power supply voltage. The conventional internal voltage generator includes a source follower transistor that drives a driver stage. In the conventional internal voltage generator, an NMOS transistor NMO generates a signal p_drv that drives the driver stage. In order to normally operate the NMOS transistor NMO, a voltage at a node P0 should be greater than VHALF+a threshold voltage Vth of the NMOS transistor. However, since the present trend is for the power supply to have lower voltage, the circuit of FIG. 1 has a limit of operation. Furthermore, when an output voltage VHALF takes a lower value, the corresponding PMOS transistor MP0, generating a signal n_drv, has difficulty being turned on. The signal n_drv is a signal for driving a pull-down driver and it may cause a pull-down operation to be abnormally performed at a lower voltage than is intended.

### SUMMARY OF THE INVENTION

Accordingly, the present invention has been made to solve the above-mentioned problems occurring in the prior art, and an object of the present invention is to provide an internal voltage generator which easily performs the restoration of an output voltage to a target value although an internal voltage varies in order to overcome the limitation according to the decrease of a power supply voltage supplied to an internal voltage generator.

In order to accomplish this object, there is provided an internal voltage generator comprising: a reference voltage divider for generating first and second reference voltages; a first differential amplifier for receiving the first reference voltage from the reference voltage divider through a first input terminal of the first differential amplifier and for generating a first differential signal; a second differential amplifier for receiving the second reference voltage from the reference voltage divider through a first input terminal of the second differential amplifier and for generating a second differential signal; and a driver being driven by the first and second differential signals from the first and second differential amplifiers, respectively, and wherein an output signal of the driver is used as an internal voltage of a semiconductor device, and is applied to the second input terminals of the first and second differential amplifiers, respectively, to provide a feedback loop, thereby maintaining the driver output signal within a predetermined target range of voltages.

Preferably, a voltage of the output signal of the driver has a magnitude greater than that of the first reference voltage and less than that of the second reference voltage. The reference voltage divider for generating first and second reference voltages may comprise either a plurality of resistors connected in series between a core voltage and a ground voltage, and the nodes through which the first and second reference voltages are outputted are disposed on opposite sides of at least one resistor, or alternatively, the reference voltage divider further comprises a reference regulator.

### BRIEF DESCRIPTION OF THE DRAWING FIGURES

The above and other objects, features and advantages of the present invention will be more apparent from the following detailed description taken in conjunction with the accompanying drawings, in which:

FIG. 1 is a circuit diagram showing a conventional internal generator for generating half of a core voltage;

FIG. 2 is a circuit diagram showing a configuration of an internal voltage generator according to a first embodiment of the present invention;

FIG. 3 is a circuit diagram showing a configuration of an internal voltage generator according to a second embodiment of the present invention;

FIG. 4 is a graph showing variations in voltages generated by the circuits shown in FIG. 2 or FIG. 3; and

FIG. 5 is a graph showing operational voltages of the internal signals of the voltage generators shown in FIG. 2 or 3.

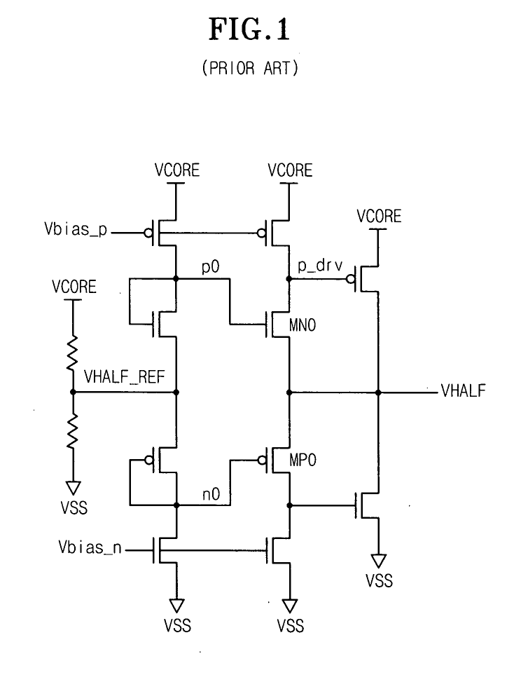

### DETAILED DESCRIPTION OF THE PREFERRED EMBODIMENTS

Hereinafter, a preferred embodiment of the present invention will be described with reference to the accompanying drawings. In the following description and drawings, the same reference indicators and numerals are used to designate the same or similar components in the different figures so repetition of the description on the same or similar components will be omitted.

Reference characters used in the specification are defined as follows.

VDD: Power supply;

VCORE: Core voltage having a potential level when the data of a high level is stored in a memory cell of a semiconductor memory device. The core voltage has a potential level less than the power supply VDD;

VSS: Ground voltage;

VREF_P: First reference voltage less than a target internal voltage;

VREF_N: Second reference voltage less than a target internal voltage;

VBAIS: Bias voltage that allows the operation of a differential amplifier; and

VHALF: Desired internal voltage as provided by the present invention.

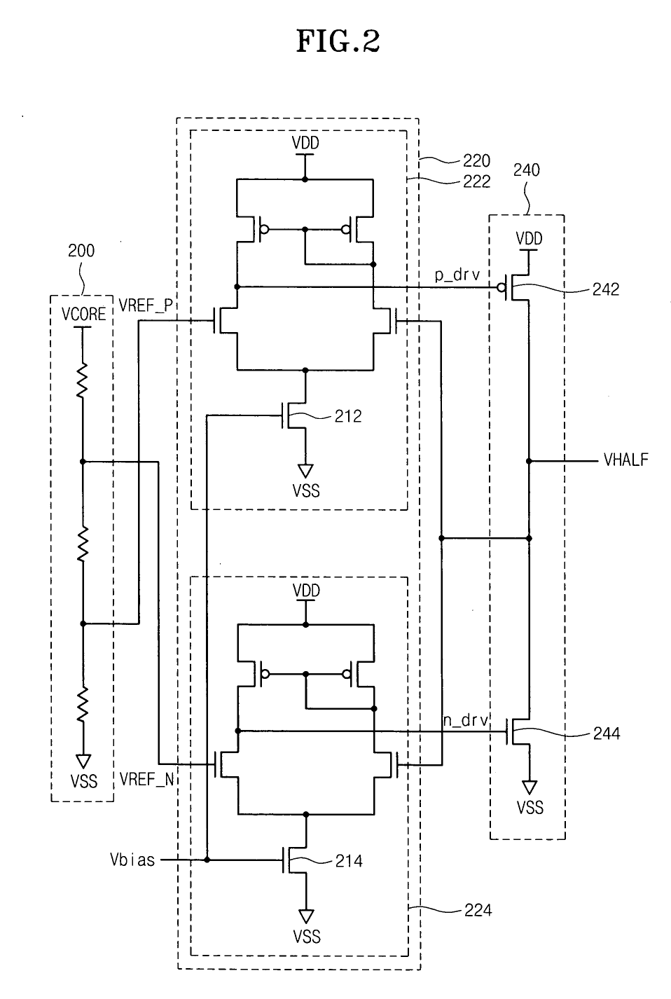

FIG. 2 is a circuit diagram showing a configuration of an internal voltage generator according to a first embodiment of the present invention. The internal voltage generator of FIG. 2 includes a reference voltage divider 200, a comparator 220, and a driver 240. The comparator 220 includes a first differential amplifier 222 and a second differential amplifier 224.

As shown in FIG. 2, the reference voltage divider 200 includes a plurality of resistors which are connected to each other in series between the core voltage VCORE and a ground voltage VSS. The reference voltage divider 200 generates the first reference voltage VREF_P and the second reference voltage VREF_N. The first reference voltage VREF_P is lower in magnitude than the second reference voltage VREF_N. A voltage of an output signal VHALF of the driver 240 is selected to be greater in magnitude than the first reference voltage VREF_P and to be less in magnitude than the second reference voltage VREF_N.

The first differential amplifier 222 and the second differential amplifier 224 defining the comparator 220 are 2-input differential amplifier. The first differential amplifier 222 generates a first differential signal p_drv. The first differential amplifier 222 includes a first input terminal and a second input terminal. The first reference voltage VREF_P is applied to the first input terminal of the first differential amplifier 222.

The second differential amplifier 224 generates a second differential signal n_drv. The second differential amplifier 224 includes a first input terminal and a second input terminal. The second reference voltage VREF_N is applied to the first input terminal of the second differential amplifier 224.

The driver 240 is driven by the first and second differential signals p_drv and n_drv received from the first and second differential amplifiers, respectively. An output signal of the driver 240 is used as an internal voltage of a semiconductor device. The output signal of the driver 240 is applied to the second input terminal of the first differential amplifier 222 and the second input terminal of the second differential amplifier 224 through feedback, respectively.

The driver 240 includes a PMOS transistor and an NMOS transistor, which are connected to each other in series between the power supply VDD and the ground voltage VSS. The first differential signal p_drv is applied to a gate of the PMOS transistor. The second differential signal n_drv is applied to a gate of the NMOS transistor. The output signal of the driver VHALF is outputted through a middle node disposed between the PMOS transistor and the NMOS transistor.

The operation of the internal voltage generator shown in FIG. 2 will be now explained.

First, in the reference voltage divider 200, a plurality of resistors are connected to each other in series between the core voltage VCORE and the ground voltage VSS. The first reference voltage VREF_P and the second reference voltage VREF_N are outputted through two nodes that are formed between the respective two resistors, thereby having different comparative voltages.

The comparator 220 includes the first differential amplifier 222 and the second differential amplifier 224. The first differential amplifier 222 drives a PMOS transistor 242, which functions as a pull-up device of the driver 240. The second differential amplifier 224 drives an NMOS transistor 244, which functions as a pull-down device of the driver 240.

The bias voltage VBIAS is inputted to the first and second differential amplifiers 222 and 224 in common. The bias voltage VBIAS is applied to the gates of two NMOS transistors 212, 214 in order to operate the first and second differential amplifiers 222 and 224, respectively. The NMOS transistors 212, 214 are used as current sources of the first and second differential amplifiers 222 and 224, respectively. The bias voltage VBIAS is preferably greater than a threshold voltage of each of the NMOS transistors 212, 214.

The first differential amplifier 222 drives a PMOS transistor 242, which functions as a pull-up device. The first differential amplifier 222 receives the first reference voltage VREF_P, which is lower in magnitude than a target value of the output voltage VHALF of the driver 240, through a first input terminal thereof. The first differential amplifier 222 receives the output voltage VHALF of the driver 240 through a second input terminal thereof through feedback. Accordingly, when the level of the output voltage VHALF of the driver 240 is lower than that of the first reference voltage VREF_P, the voltage level of the first differential signal p_drv becomes low enough to drive the pull-up PMOS transistor 242, thereby causing the level of the output voltage VHALF of the driver 240 to be increased. The first differential signal p_drv is an output voltage of the first differential amplifier 222. However, when the level of the increased output voltage VHALF of the driver 240 becomes higher in magnitude than that of the first reference voltage VREF_P, the voltage level of the first differential signal p_drv becomes high enough to turn off the PMOS transistor 242, and stops its functioning as a pull-up device. Consequently, the level of the output voltage VHALF of the driver 240 is maintained at a level greater than the first reference voltage VREF_P during normal operation.

The second differential amplifier 224 drives an NMOS transistor 244, which functions as a pull-down device. The second differential amplifier 224 receives the second reference voltage VREF_N that is greater in magnitude than the target value of the output voltage VHALF of the driver 240, through a first input terminal thereof. The second differential amplifier 224 receives the output voltage VHALF of the driver 240 through a second input terminal thereof through feedback. Accordingly, when the level of the output voltage VHALF of the driver 240 is higher in magnitude than that of the second reference voltage VREF_N, a voltage level of the second differential signal n_drv becomes high enough to drive the PMOS transistor functioning as the pull-down device, thereby causing the level of the output voltage VHALF of the driver 240 to be reduced. The second differential signal n_drv is an output voltage of the second differential amplifier 224. However, when the level of the reduced output voltage VHALF of the driver 240 becomes lower than that of the second reference voltage VREF_N, the voltage level of the second differential signal n_drv becomes low enough to turn off the PMOS transistor 244 thereby stopping its functioning as a pull-down device. Consequently, the level of the output voltage VHALF of the driver 240 is maintained at a level lower than the second reference voltage VREF_N during normal operation.

In the operation of the driver 240, the PMOS transistor 242 and the NMOS transistor 244 defining the driver 240 are controlled in a tri-state condition. The PMOS transistor 242 functions as a pull-up device and the NMOS transistor 244 functions as a pull-down device. The three functions states are described below.

When the output voltage VHALF of the driver 240 has a value greater than the first reference voltage VREF_P and less than the second reference voltage VREF_N, the PMOS transistor functioning as the pull-up device and the NMOS transistor functioning as the pull-down device are all turned on.

When the output voltage VHALF of the driver 240 has a value greater than the second reference voltage VREF_N, the pull-up PMOS transistor 242 is turned off but the pull-down NMOS transistor 244 is turned on to lower the output voltage VHALF of the driver 240.

When the output voltage VHALF of the driver 240 has a value less than the first reference voltage VREF_P, the pull-up PMOS transistor 242 is turned on but the pull-down NMOS transistor 244 is turned off to increase the output voltage VHALF of the driver 240.

Accordingly, the output voltage VHALF of the internal voltage generator according, to the present invention is maintained at a value between the first reference voltage VREF_P and the second reference voltage VREF_N.

In accordance with the present invention, the output voltage VHALF ranges between the first reference voltage VREF_P and the second reference voltage VREF_N. By suitably adjusting the resistance value of the reference voltage divider 200, the variation range may be reduced as desired. Also, the average voltage level of the output voltage VHALF may be adjusted to be increased or reduced by controlling the resistance ratio of the reference voltage divider 200.

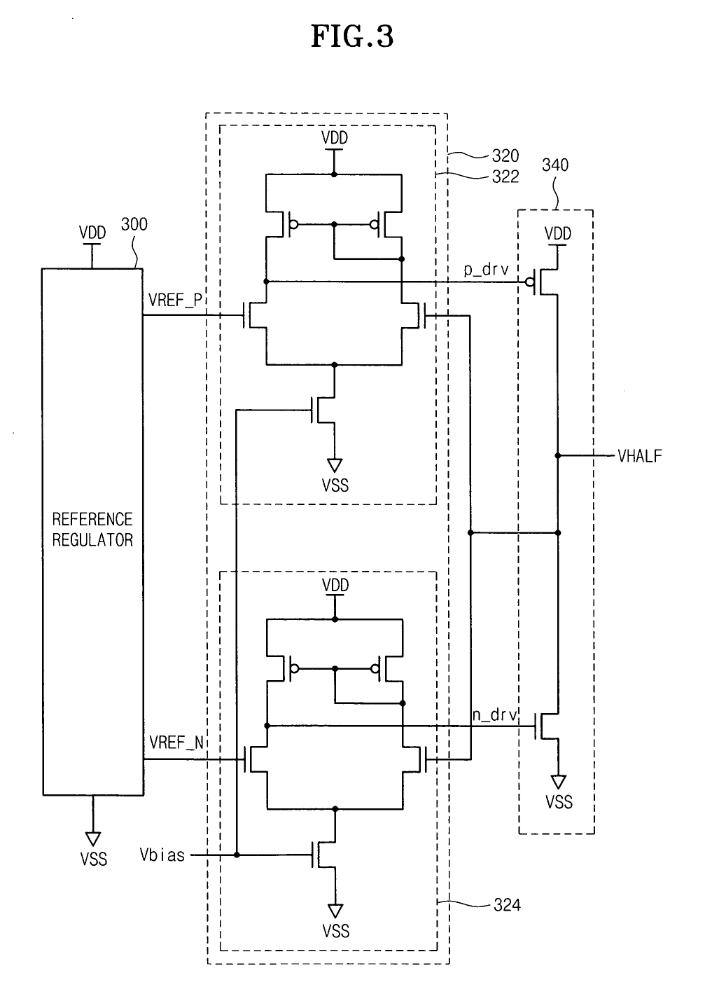

FIG. 3 is a circuit diagram showing a configuration of an internal voltage generator according to a second embodiment of the present invention.

The internal voltage generator of FIG. 3 differs from the internal voltage generator of FIG. 2 in that it generates first and second reference voltages VREF_P and VREF_N using a typical reference voltage generator (reference regulator), 300, as shown. That is, the internal voltage generator according to the second embodiment of the present invention uses the typical reference voltage generator (reference regulator) 300, which is operated by a power supply voltage VDD. Since the second embodiment generates a more stable reference voltage than the first embodiment which uses the core voltage VCORE, it generates an output voltage VHALF which is not interlocked with the core voltage VCORE. The core voltage VCORE is a kind of internal voltage, and is not necessary for use in the operation of the second embodiment of the present invention.

As stated above, the internal voltage generator according to the present invention is used to generate a bit line precharge voltage or a cell plate voltage of a memory device. Additionally, the internal voltage generator may be used to provide a variety of functional internal voltage generators for use in a semiconductor memory device.

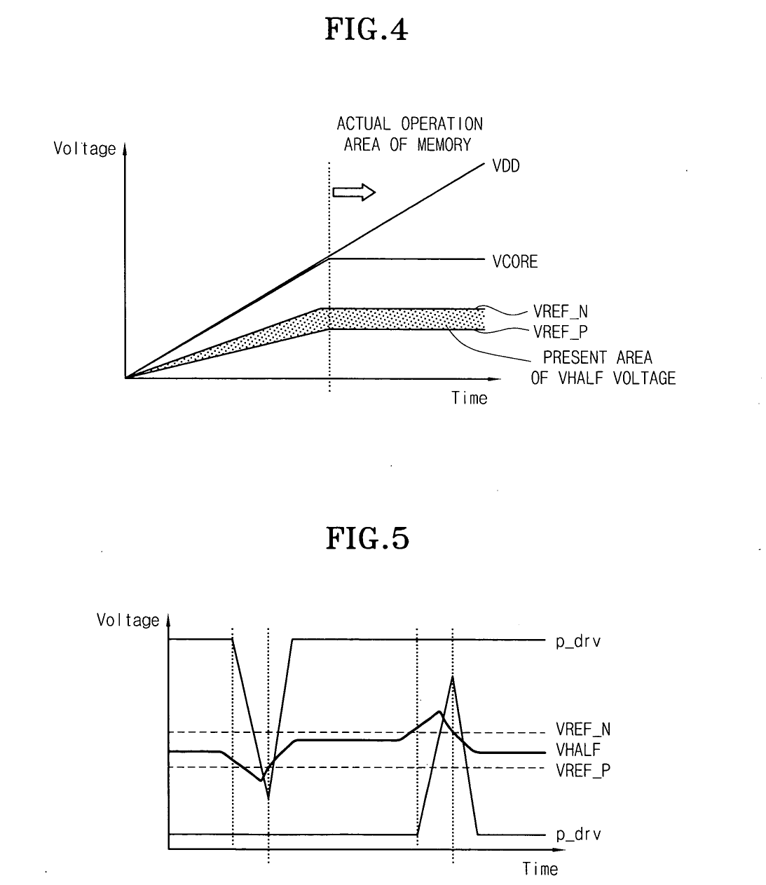

FIG. 4 is a graph showing variations of the voltages produced by the devices shown in FIG. 2 or FIG. 3 during increase of a power supply voltage VDD, which is applied to a semiconductor memory device. As shown in FIG. 4, after the power supply voltage VDD is applied to the semiconductor memory device, when a predetermined time lapses, a desired internal voltage VHALF achieves a value between the first reference voltage VREF_P and the second reference voltage VREF_N, as shown by the present AREA OF HALFV VOLTAGE.

FIG. 5 is a graph showing operation of either the internal voltage generator shown in FIG. 2 or 3 when the semiconductor memory device operates.

As shown in FIG. 5, when the internal voltage VHALF generated by the internal voltage generator changes, namely, when the level of the internal voltage VHALF having a value between the first reference voltage VREF_P and the second reference voltage VREF_N is reduced due to the operation of the semiconductor memory device, the first differential signal p_drv is reduced to a low level. The first differential signal p_drv is an output of the first differential amplifier. Also, when the difference between a source voltage VDD of the PMOS transistor and the voltage of the first differential signal p_drv becomes greater than a threshold voltage Vth of the PMOS transistor, the PMOS transistor is turned on to increase and maintain the internal voltage VHALF to have a value between the first reference voltage VREF_P and the second reference voltage VREF_N. The PMOS transistor functions as a pull-up device.

In the same manner, when the level of the internal voltage VHALF having a value between the first reference voltage VREF_P and the second reference voltage VREF_N is increased due to some cause, the second differential signal n_drv is increased to a high level. The second differential signal n_drv is an output of the second differential amplifier. Also, when the difference between a source voltage VDD of the NMOS transistor and the second differential signal n_drv becomes greater than a threshold voltage Vth of the NMOS transistor, the NMOS transistor is turned on to increase and maintain the internal voltage VHALF to have a value between the first reference voltage VREF_P and the second reference voltage VREF_N. The NMOS transistor functions as a pull-down device.

As described previously, in the present invention, the output voltage VHALF ranges between the first reference voltage VREF_P and the second reference voltage VREF_N. By suitably adjusting the resistance value of the reference voltage divider 200 or the reference regulator 300, the variation range is reduced. Also, an average voltage level of the output voltage VHALF is adjusted to be increased or reduced by controlling the resistance ratio of the reference voltage divider 200.

As mentioned above, the present invention outputs a stable constant internal voltage VHALF although the power supply voltage may be reduced by using a core voltage for an internal voltage as a power supply voltage for use in an internal voltage divider.

In accordance with the internal voltage generator according to the present invention, although an internal voltage may vary due to some cause, an output voltage is easily restored to a target value. Accordingly, a semiconductor device having the internal voltage generator is operated having a stable power source voltage.

Although preferred embodiments of the present invention have been described for illustrative purposes, those skilled in the art will appreciate that various modifications, alterations, additions and substitutions are possible, without departing from the scope and spirit of the invention as claimed in the accompanying claims.

What is claimed is:

1. An internal voltage generator comprising:
a reference voltage divider for generating first and second reference voltages;
a first differential amplifier for receiving the first reference voltage from the reference voltage divider through a first input terminal of the first differential amplifier and for generating a first differential signal;
a second differential amplifier for receiving the second reference voltage from the reference voltage divider through a first input terminal of the second differential amplifier and for generating a second differential signal; and
a driver being driven by the first and second differential signals from the first and second differential amplifiers, respectively, and
wherein an output signal of the driver is used as an internal voltage of a semiconductor device, and is applied to second input terminals of the first and second differential amplifiers, respectively to provide a feedback loop, thereby maintaining the driver output signal within a predetermined target range of voltages.

2. An internal voltage generator as claimed in claim 1, wherein the first reference voltage is less than the second reference voltage.

3. An internal voltage generator as claimed in claim 1, wherein the voltage of the output signal of the driver has a magnitude greater than the first reference voltage and less than the second reference voltage.

4. An internal voltage generator as claimed in claim 1, wherein the driver includes a PMOS transistor and an NMOS transistor which are connected to each other in series, and the first and second differential signals are applied to gates of the PMOS transistor and the NMOS transistor, respectively.

5. An internal voltage generator as claimed in claim 4, wherein the output signal of the driver is outputted through a middle node between the PMOS transistor and the NMOS transistor.

6. An internal voltage generator as claimed in claim 1, wherein the semiconductor device generates a second internal voltage other than the internal voltage of the semiconductor device, and the a second internal voltage is used for providing a power supply voltage of the reference voltage divider.

7. An internal voltage generator comprising:
a reference voltage divider for generating first and second reference voltages;
a first differential amplifier for receiving the first reference voltage from the reference voltage divider through a first input terminal of the first differential amplifier and for generating a first differential signal;
a second differential amplifier for receiving the second reference voltage from the reference voltage divider through a first input terminal of the second differential amplifier and for generating a second differential signal;
a driver being driven by the first differential signal received from the first differential amplifier to maintain the voltage level of a driver output signal above the first reference voltage received from the reference voltage divider; and
the driver being driven by the second differential signal received from the second differential amplifier to maintain the voltage level of a driver output signal below the second reference voltage received from the reference voltage divider,
wherein an output signal of the driver is used as an internal voltage of a semiconductor device, and is applied to second input terminals of the first and second differential amplifiers, respectively to provide a feedback loop, thereby maintaining the driver output signal within a predetermined target range of voltages defined by the first and second reference voltages.

8. An internal voltage generator as claimed in claim 7, wherein the reference voltage divider further comprises a plurality of resistors connected in series between a core voltage and a ground voltage, and the nodes through which the first and second reference voltages are outputted are disposed on opposite sides of at least one resistor.

9. An internal voltage generator as claimed in claim 7, wherein the reference voltage divider further comprises a reference regulator.
